(19) United States
(12) Patent Application Publication
(10) Pub. No.: US 2018/0119396 A1
(43) Pub. Date: May 3, 2018

(54) MANUAL WATER-FEEDING MECHANISM FOR SENSOR FAUCET

(71) Applicant: FLUSHTECH CORPORATION, TAOYUAN CITY (TW)

(72) Inventor: BIN-HAN HUANG, TAIPEI (TW)

(21) Appl. No.: 15/349,265

(22) Filed: Nov. 11, 2016

(30) Foreign Application Priority Data
Oct. 28, 2016 (TW) 105216466

(51) Int. Cl. E03C 1/04; E03C 1/05; F16K 11/00; F16K 31/06

(52) U.S. Cl. CPC E03C 1/0412; F16K 31/0641; F16K 19/006; E03C 1/057

(57) ABSTRACT

A manual water-feeding mechanism for a sensor faucet includes: a base connected to at least one water inlet; a solenoid seat connected to a water outlet of a water pipe directed to the faucet; a base containing therein a first channel communicated to a water inlet and a second channel in the solenoid seat, wherein a solenoid diaphragm controls open and close of the second channel; a third channel, communicated to the first channel from its lateral side; a fourth channel having one end connected to third channel and an opposite end connected to second channel behind the solenoid diaphragm; and a manual stem having one end abutting between a middle section and an exit of the third channel. The manual stem when rotated allows water to flow through the third channel, the fourth channel and the second channel to the water pipe.

### BACKGROUND OF THE INVENTION

### 1. Technical Field

The present invention relates to a water-feeding mechanism for faucets, and more particularly to a manual water-feeding mechanism for sensor faucets.

### 2. Description of Related Art

A sensor faucet senses a user's request of water feeding and automatically feeds water. However, its operation depends on electricity and fails to work in cases of power failure or no charge in its battery. For addressing this problem, sensor faucets with manual water-feeding function have been developed, some of which also incorporate the technology of mixing cold and hot water.

In the existing sensor faucets that support manual water feeding, an additional and complicated piping mechanism has to be installed for allowing switch between automatic and manual water feeding. Such a mechanism significantly complicates the manufacturing of faucets and in turn increases the costs and process of the final products. Hence, there is a need for improving the existing devices.

### SUMMARY OF THE INVENTION

In view of the unmet needs in the prior art, the present invention provides a manual water-feeding mechanism for sensor faucets. In an first aspect, the mechanism comprises: a base whose bottom is connected to at least one water inlet; a solenoid seat whose top is communicated with a water outlet of the faucet through a water pipe, wherein the base defines therein a first channel that has one end communicated with the water inlet and an opposite end connected to a second channel in the solenoid seat; and a solenoid diaphragm controlling open and close of the second channel so that when the second channel is open, water from the water inlet is allowed to flow through the second channel and the water pipe and flow out at the water outlet of the faucet; the manual water-feeding mechanism being characterized in: a third channel, which is formed in the base beside the first channel and communicated with the first channel, and has an exit formed at an upper surface of the base; a fourth channel, which is formed in the solenoid seat beside the second channel and has one end connected to the third channel and an opposite end connected to the second channel behind the solenoid diaphragm; and a manual stem, which is rotatably connected to the lateral side of the base and has one end abutting between a middle section and the exit of the third channel, so that when the manual stem is manually rotated, it guides the water from the water inlet to pass through the third channel, the fourth channel, the second channel and the water pipe and flow out at the water outlet of the faucet.

In the manual water-feeding mechanism of the first aspect, preferably, there is a ditch extending from the exit of the third channel at the upper surface of the base.

In the manual water-feeding mechanism of the first aspect, preferably, there is a seal circling the ditch and the opposite end of the first channel at the upper surface of the base.

In the manual water-feeding mechanism of the first aspect, preferably, an entrance of the second channel is formed as a trough at the bottom of the solenoid seat.

In the manual water-feeding mechanism of the first aspect, preferably, the fourth channel is parallel to the second channel.

In the manual water-feeding mechanism of the first aspect, preferably, the manual stem is externally capped by a cap and, preferably, the cap externally has a lever.

In a second aspect of the present invention, a manual water-feeding mechanism for sensor faucets comprises: a base whose bottom is connected to a hot water inlet and a cold water inlet; a solenoid seat whose top is communicated to a water outlet of the faucet through a water pipe; a mixing stem that is located at the lateral side of the base and has an axially extending mixing channel and a cold feeder, a hot feeder, and a confluence vertically connected to the mixing channel, in which the cold and hot feeders are connected to two water inlets, respectively; wherein the base defines therein a first channel that has one end connected to the confluence of the mixing stem and an opposite end connected to a second channel in the solenoid seat; and a solenoid diaphragm controlling open and close of the second channel so that when the second channel is open, water from the water inlet is allowed to flow through the mixing channel of the mixing stem, the first channel, the second channel and the water pipe and flow out at the water outlet of the faucet; the manual water-feeding mechanism being characterized in:

a third channel, which is formed at an exit of the mixing channel of the mixing stem in the base and communicated with the mixing channel, and has an exit formed at an upper surface of the base and a ditch extending from the exit at the upper surface of the base;

a fourth channel, which is formed in the solenoid seat beside the second channel and has an entrance connected to a tail end of the ditch of the third channel and an exit connected to the second channel behind the solenoid diaphragm; and

a manual stem, which is rotatably connected to the lateral side of the base and aligned with the mixing stem, and has one end abutting between an exit of the mixing channel of the mixing stem and an entrance of the third channel, so that when the manual stem is manually rotated, it guides the water from the water inlet to pass through the mixing channel, the third channel, the fourth channel, the second channel and the water pipe and flow out at the water outlet of the faucet.

In the manual water-feeding mechanism of the second aspect, preferably, the mixing stem and the manual stem are each externally capped by a cap that externally has a lever.

In the manual water-feeding mechanism of the second aspect, preferably, the mixing stem and the manual stem are coaxially aligned with each other.

With the fourth channel provided beside the second channel of the solenoid seat, the manual water-feeding mechanisms as described previously easily enables manual water feeding. The present invention thus simplifies piping of faucet and reduces the overall manufacturing costs as compared to the prior art.

The invention as well as a preferred mode of use, further objectives and advantages thereof will be best understood by reference to the following detailed description of illustrative embodiments when read in conjunction with the accompanying drawings.

### BRIEF DESCRIPTION OF THE DRAWINGS

FIG. 1 is a perspective view of a manual water-feeding mechanism according to the present invention.

FIG. 2 is an exploded view of the manual water-feeding mechanism showing its base and solenoid seat.

FIG. 3 is a cross-sectional view of the manual water-feeding mechanism taken from the front of the first preferred embodiment of the present invention.

FIG. 4 is a schematic drawing showing the operation of the manual stem of the manual water-feeding mechanism.

FIG. 5 is a cross-sectional view of the manual water-feeding mechanism taken from the lateral of the first preferred embodiment of the present invention.

FIG. 6 is a partial, enlarged view of FIG. 5.

FIG. 7 is a cross-sectional view of a manual water-feeding mechanism taken from the front of a second preferred embodiment of the present invention.

### DETAILED DESCRIPTION OF THE INVENTION

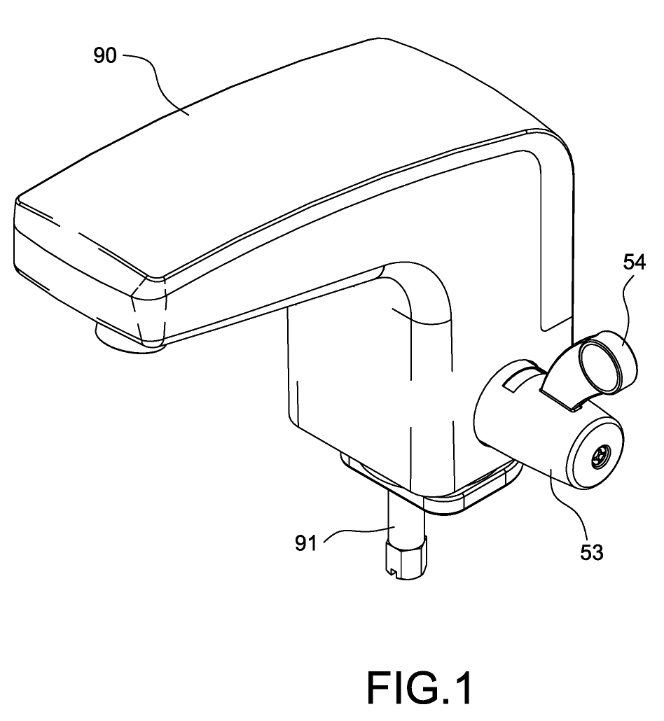

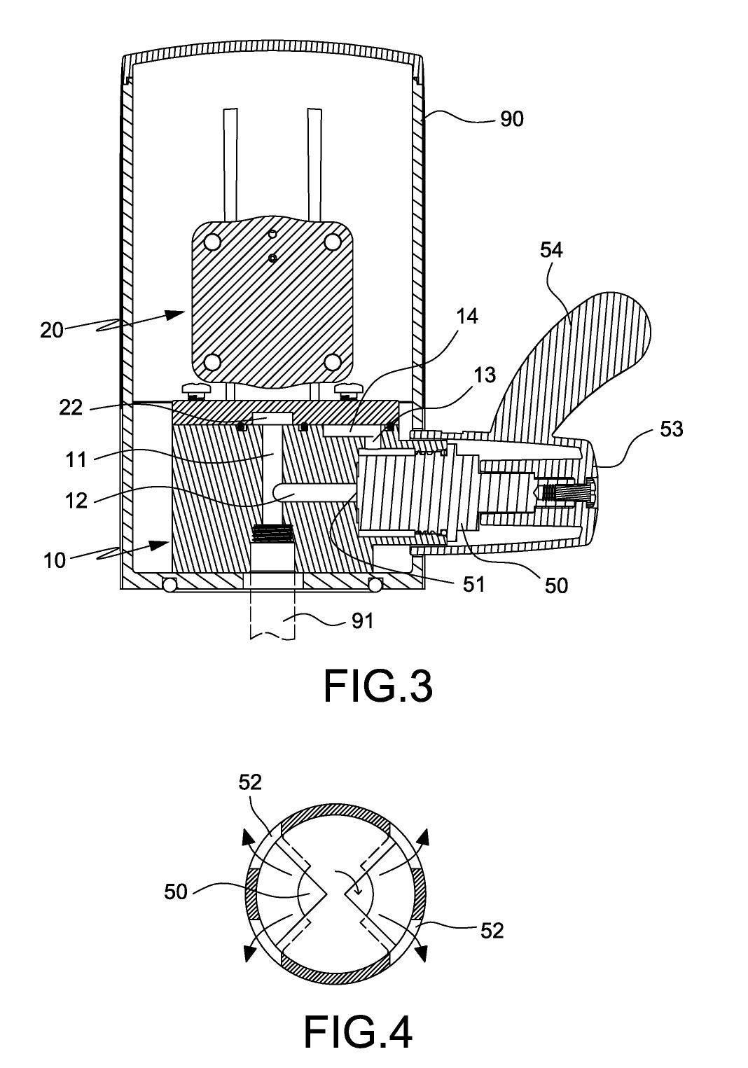

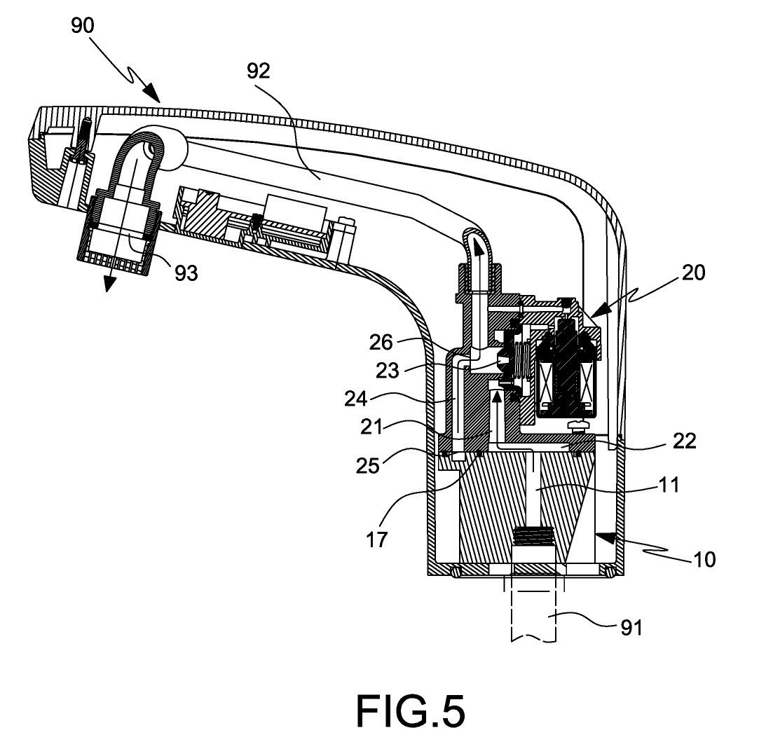

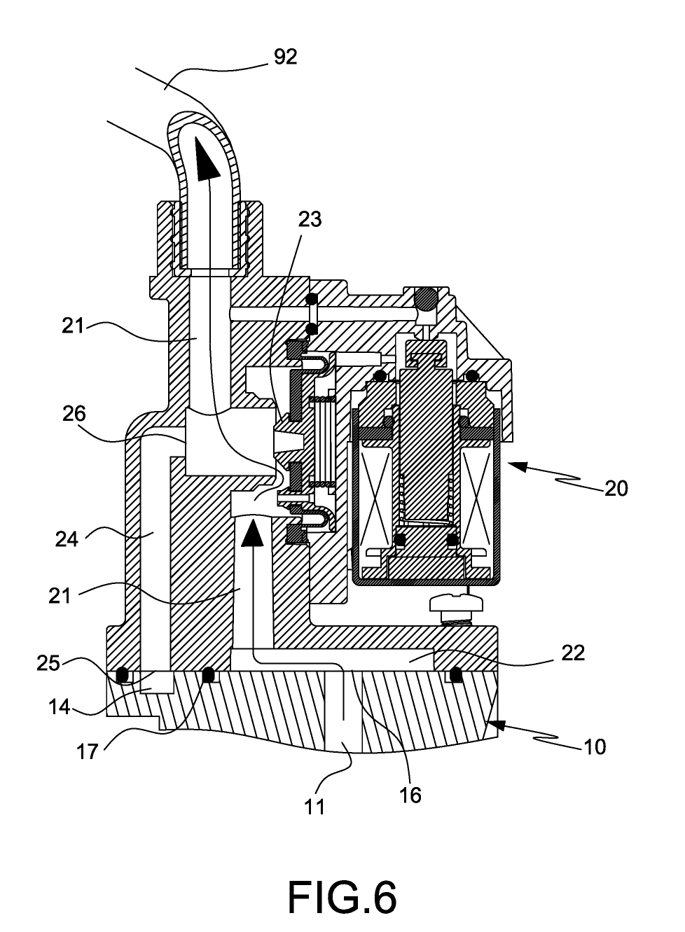

As showing on FIGS. 1 through 6, a manual water-feeding mechanism as disclosed for sensor faucets is installed in a faucet housing 90 conventionally. The mechanism comprises: a base 10 whose bottom connected to a water inlet 91; and a solenoid seat 20 whose top connected to a water outlet 93 of the faucet through a water pipe 92. The base 10 defines therein a first channel 11 that has one end communicated with the water inlet 91 and an opposite end connected to an entrance 22 of a second channel 21 in the solenoid seat 20. A solenoid diaphragm 23 is configured to block or open the entrance 22, thereby controlling water to or not to flow from the source into the second channel 21. In the open case, water from the water source flows through the water inlet 91, the first channel 11, the second channel 21 and the water pipe 92, before flowing out at the water outlet 93 of the faucet.

The manual water-feeding mechanism the first preferred embodiment of the present invention is characterized in a third channel 12, a fourth channel 24, and a manual stem 50. The third channel 12 is located in the base 10 and is communicated with the first channel 11 at the lateral side of the first channel. The third channel 12 has an exit 13 formed at the upper surface of the base 10 from which a ditch 14 extends on the upper surface of the base. The fourth channel 24 is located inside the solenoid seat 20 and besides the second channel 21 and may be parallel or not parallel to the second channel 21. The fourth channel 24 has an entrance 25 connected to a tail end 15 of the ditch 14 of the third channel 12. The fourth channel 24 is communicated with the second channel 21 and has an exit 26 located in a channel section of the second channel 21 behind the solenoid diaphragm 23. The manual stem 50 connected to the lateral side of the base 10 in a rotatable manner. The manual stem 50 has a flow-in end 51 abutting between the middle section of the third channel 12 and the exit 13.

In the manual water-feeding mechanism of the first preferred embodiment as described previously, water enters from the water inlet 91 and flows through the first channel 11 to enter the front section of the second channel 21. When the solenoid works, the solenoid diaphragm 23 then opens and allows water to flow into the rear section of the second channel 21 and the water pipe 92, and finally flow out at the water outlet 93 of the faucet. On the other hand, when the solenoid fails, a user can rotate the manual stem 50 to change its angle (which usually means to make a 90-degree displacement, as shown in FIG. 4), so that water in the third channel 12 flows out of a gate 52 of the manual stem 50 and advances through the exit 13 of the third channel and the ditch 14 extending therefrom. Afterward, the water flows through the tail end 15 of the ditch 14, the entrance 25 of the fourth channel 24, the fourth channel 24, its exit 26, the rear section of the second channel 21, and the water pipe 92 before it finally flows out at the water outlet 93 of the faucet.

In the manual water-feeding mechanism as described previously, for easy and convenient rotation of the manual stem 50, the manual stem 50 may be capped at its end externally by a cap 53 that has a lever 54 attached thereto.

In the manual water-feeding mechanism as described previously, the entrance 22 of the second channel 21 is formed as a trough on the bottom of the solenoid seat 20 for accumulating the water coming from the first channel 11 before guiding the water into the second channel 21. Therefore, the junction between the first channel 11 and the second channel 21 can be made without precise engagement. The same design is applied to the ditch 14 extending from the exit 13 of the third channel 12.

In the manual water-feeding mechanism as described previously, for preventing leakage at junctions between the channels in the base 10 and in the solenoid seat 20, a seal 17 is provided to circle the ditch 14 and the exit 16 of the first channel 11 at the top of the base 10. It is to be noted that the seal 17 as depicted is illustrative and not limitative.

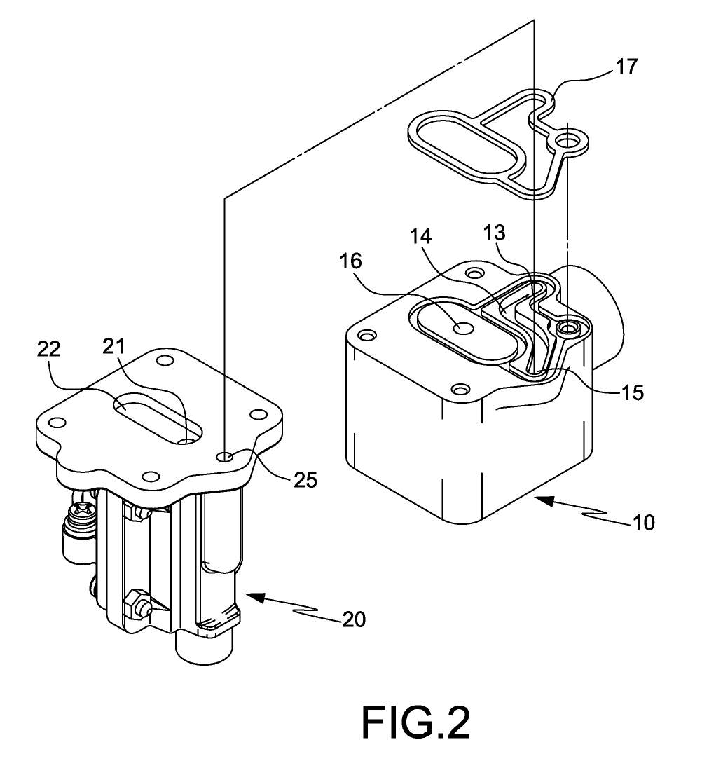

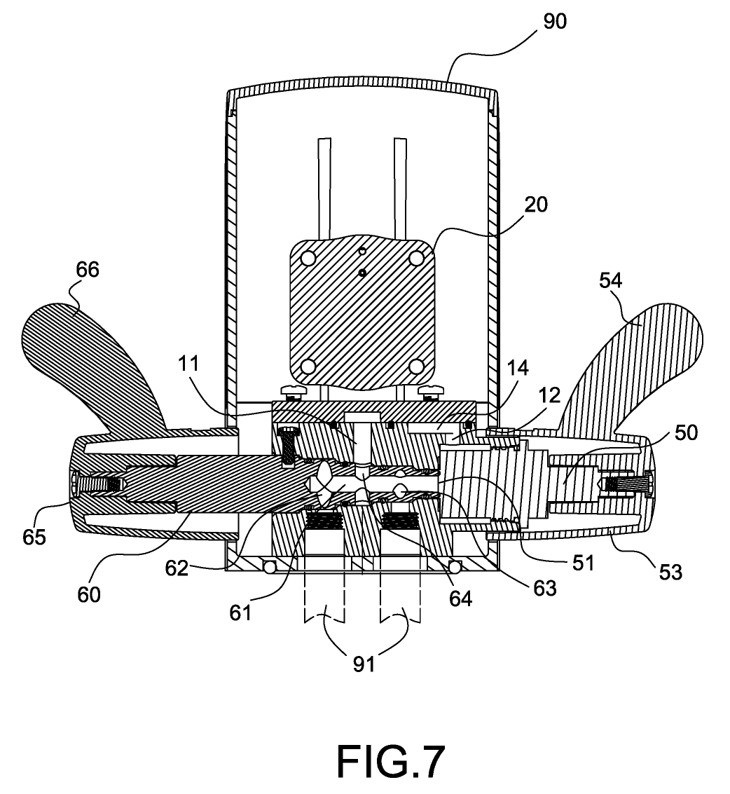

Referring to FIG. 2 and FIGS. 4 through 7, in addition to the manual water-feeding mechanism of the first preferred embodiment that is designed for faucets using a single water source, the present invention herein provides a second preferred embodiment wherein a manual water-feeding mechanism is applicable to sensor faucets working with multiple water sources, such as cold water and hot water. The manual water-feeding mechanism of the second preferred embodiment of the present invention comprises: a base 10 whose bottom is connected to a hot water inlet 91 and a cold water inlet 91; a solenoid seat 20 whose top is connected to a water outlet 93 of the faucet through a water pipe 92; and a mixing stem 60 located beside the base (as shown in FIG. 7). The mixing stem 60 has a mixing channel 61 extending axially and has a cold feeder 62, a hot feeder 63 and a confluence 64 vertically connected to the mixing channel. The cold and hot feeders 62, 63 are connected to two water inlets 91, respectively. The base 10 contains therein a first channel 11 that has one end connected to the confluence 64 of the mixing stem 60 and an opposite end connected to an entrance 22 of a second channel 21 in the solenoid seat 20. Under control of a solenoid diaphragm 23 installed in the second channel 21, water is allowed to enter from the cold and hot water inlets 91 and pass through the mixing channel 61 of the mixing stem 60, the first channel 11, the second channel 21 and water pipe 92, before finally flowing out of the water outlet 93 of the faucet.

With the mixing stem 60 additionally provided in the manual water-feeding mechanism of the second preferred embodiment, the layout of the channels is changed. The front section of the third channel 12 is replaced by the mixing stem 60 so the third channel 12 only has its rear section remained at the exit of the mixing channel 61 of the mixing stem 60 and communicated with the mixing channel. The fourth channel 24 is unchanged in terms of structure and position with respect to the first preferred embodiment. The manual stem 50 is similarly rotatably connected to the lateral side of the base 10 and aligned with the mixing stem 60. The manual stem 50 has its flow-in end 51 abutting between the exit of the mixing channel 61 of the mixing stem 60 and the entrance between the third channel 12.

In the manual water-feeding mechanism of the second preferred embodiment as described previously, when the manual stem 50 is rotated, it allows water from the water source(s) to flow through the water inlet(s) 91, the mixing channel 61 of the mixing stem 60, the third channel 12, the fourth channel 24, the rear section of the second channel 21, and water pipe 92, and to finally flow out at the water outlet 93 of the faucet.

In the manual water-feeding mechanism of the second preferred embodiment as described previously, the mixing stem 60 is similar to the manual stem 50 for being externally capped by a cap 65 that has a lever 66 attached thereto for convenient rotation of the mixing stem 60.

In the manual water-feeding mechanism of the second preferred embodiment as described previously, the mixing stem 60 and the manual stem 50 are coaxially aligned with each other. However, in other embodiments, they may be aligned in a non-coaxial manner or they may be not aligned with each other.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A manual water-feeding mechanism for a sensor faucet, comprising: a base whose bottom is connected to at least one water inlet; a solenoid seat whose top is communicated with a water outlet of the faucet through a water pipe, wherein the base defines therein a first channel that has one end communicated with the water inlet and an opposite end connected to a second channel in the solenoid seat; and a solenoid diaphragm controlling open and close of the second channel so that when the second channel is open, water from the water inlet is allowed to flow through the second channel and the water pipe and flow out at the water outlet of the faucet; the manual water-feeding mechanism being characterized in:
a third channel, which is formed in the base beside the first channel and communicated with the first channel, and has an exit formed at an upper surface of the base;
a fourth channel, which is formed in the solenoid seat beside the second channel and has one end connected to the third channel and an opposite end connected to the second channel behind the solenoid diaphragm; and
a manual stem, which is rotatably connected to the lateral side of the base and has one end abutting between a middle section and the exit of the third channel, so that when the manual stem is manually rotated, it guides the water from the water inlet to pass through the third channel, the fourth channel, the second channel and the water pipe and flow out at the water outlet of the faucet.

2. The manual water-feeding mechanism of claim 1, further comprising a ditch extending from the exit of the third channel at the upper surface of the base.

3. The manual water-feeding mechanism of claim 2, further comprising a seal circling the ditch and the opposite end of the first channel at the upper surface of the base.

4. The manual water-feeding mechanism of claim 1, wherein an entrance of the second channel is formed as a trough at the bottom of the solenoid seat.

5. The manual water-feeding mechanism of claim 1, wherein the fourth channel is parallel to the second channel.

6. The manual water-feeding mechanism of claim 1, wherein the manual stem is externally capped by a cap.

7. The manual water-feeding mechanism of claim 6, wherein the cap externally has a lever.

8. A manual water-feeding mechanism for a sensor faucet, comprising: a base whose bottom is connected to a hot water inlet and a cold water inlet; a solenoid seat whose top is communicated to a water outlet of the faucet through a water pipe; a mixing stem that is located at the lateral side of the base and has an axially extending mixing channel and a cold feeder, a hot feeder, and a confluence vertically connected to the mixing channel, in which the cold and hot feeders are connected to two water inlets, respectively; wherein the base defines therein a first channel that has one end connected to the confluence of the mixing stem and an opposite end connected to a second channel in the solenoid seat; and a solenoid diaphragm controlling open and close of the second channel so that when the second channel is open, water from the water inlet is allowed to flow through the mixing channel of the mixing stem, the first channel, the second channel and the water pipe and flow out at the water outlet of the faucet; the manual water-feeding mechanism being characterized in:
a third channel, which is formed at an exit of the mixing channel of the mixing stem in the base and communicated with the mixing channel, and has an exit formed at an upper surface of the base and a ditch extending from the exit at the upper surface of the base;
a fourth channel, which is formed in the solenoid seat beside the second channel and has an entrance connected to a tail end of the ditch of the third channel and an exit connected to the second channel behind the solenoid diaphragm; and
a manual stem, which is rotatably connected to the lateral side of the base and aligned with the mixing stem, and has one end abutting between an exit of the mixing channel of the mixing stem and an entrance of the third channel, so that when the manual stem is manually rotated, it guides the water from the water inlet to pass through the mixing channel, the third channel, the fourth channel, the second channel and the water pipe and flow out at the water outlet of the faucet.

9. The manual water-feeding mechanism of claim 8, wherein the mixing stem and the manual stem are each externally capped by a cap that externally has a lever.

10. The manual water-feeding mechanism of claim 8, wherein the mixing stem and the manual stem are coaxially aligned with each other.
